(19) United States
(12) Patent Application Publication
(10) Pub. No.: US 2018/0233258 A1
(43) Pub. Date: Aug. 16, 2018

(54) Fe-Based, Soft Magnetic Alloy

(71) Applicant: CRS Holdings, Inc., Wilmington, DE (US)

(72) Inventors: Chins Chinnasamy, Lancaster, PA (US); Samuel J. Kernion, Lancaster, PA (US); James F. Scanlon, Wyomissing, PA (US)

(21) Appl. No.: 15/897,615

(22) Filed: Feb. 15, 2018

Related U.S. Application Data
(60) Provisional application No. 62/459,284, filed on Feb. 15, 2017.

(51) Int. Cl. H01F 1/153; C22C 38/16; C22C 38/14; C22C 38/12; C22C 38/10; C22C 38/02; C22C 38/04; C22C 38/00

(52) U.S. Cl. CPC H01F 1/15308; C22C 38/16; C22C 38/14; C22C 38/12; B22F 9/082; C22C 38/02; C22C 38/04; C22C 38/002; H01F 1/15316; C22C 38/10

(57) ABSTRACT

An Fe-base, soft magnetic alloy is disclosed. The alloy has the general formula Fe_{100 a-b-c-d-x-y} MₐM′_{b}M″_{c}M′″_{d}PₓMn_{y} where M is Co and/or Ni, M′ is one or more of Zr, Nb, Cr, Mo, Hf, Sc, Ti, V, W, and Ta, M″ is one or more of B, C, Si, and Al, and M″' is selected from the group consisting of Cu, Pt, Ir, Zn, Au, and Ag. The subscripts a, b, c, d, x, and y represent the atomic proportions of the elements and have the following atomic percent ranges:

0≤a≤10,

0≤b≤7,

5≤c≤20,

0≤d≤5,

0.1≤x≤15, and

0.1≤y≤5.

The balance of the alloy is iron and usual impurities. Alloy powder, a magnetic article made therefrom, and an amorphous metal article made from the alloy are also disclosed.

### CROSS-REFERENCE TO RELATED APPLICATION

This application claims the benefit of provisional application No. 62/459,284, filed Feb. 15, 2017, the entirety of which is incorporated herein by reference.

### BACKGROUND OF THE INVENTION

### Field of the Invention

The present invention relates to an Fe-based alloy having excellent magnetic properties, and more particularly to an Fe-based soft magnetic alloy in the form of alloy powder or thin strip and having high saturation magnetization suitable for the magnetic cores of inductors, actuators, transformers, choke coils, and reactors. The invention also relates to a method of producing such articles.

### Description of the Related Art

The known amorphous and nanocrystalline soft magnetic powders and the magnetic cores made from such powders provide very good soft magnetic properties including high saturation magnetization, low coercivity, and high permeability. Conventional magnetic materials such as ferrites are used in magnetic cores of components that operate at high frequencies, e.g., 1000 Hz and higher, because of their high electrical resistivity and low eddy current loss. Such high excitation frequencies lead to higher power density and lower operating cost in $/kW, but also result in higher losses and lower efficiency because of increased eddy currents in the material. Ferrites have relatively low saturation magnetization and high electrical resistivity. Therefore, it is difficult to produce small ferrite cores for high frequency transformers, inductors, choke coils and other power electronic devices and also have acceptable magnetic properties and electrical resistivity. Magnetic cores made from thin Si-steel laminations provide reduced eddy currents, but such thin laminations often have poor stacking factor. They also require additional manufacturing costs because the steel laminations are punched to shape from strip or sheet material and are then stacked and welded together. In contrast, amorphous magnetic powder can be formed directly to a desired shape in a single forming operation such as metal injection molding.

At high excitation frequencies cores formed from soft magnetic electrical steel laminations have more core loss than cores made from amorphous magnetic powder. In amorphous powder cores, eddy current loss can be reduced compared with the surface laminated electrical steels by coating the particles with an electrically insulating material. This minimizes eddy current losses by confining the eddy currents to the individual powder particles. Also, a soft magnetic powder core can be more easily formed in various shapes and therefore such “dust cores” are more easily produced compared to cores made from magnetic steel sheets or from ferrites.

### SUMMARY OF THE INVENTION

In accordance with a first aspect of the present invention there is provided an Fe-base soft magnetic alloy having the general formula Fe_{100 a-b-c-d-x-y} MₐM′_{b}M″_{c}M′″_{d}PₓMn_{y}. In the alloy of this invention M is one or both of Co and Ni; M′ is one or more elements selected from the group consisting of Zr, Nb, Cr, Mo, Hf, Sc, Ti, V, W, and Ta; M″ is one or more elements selected from the group consisting of B, C, Si, and Al; and M′″ is selected from the group consisting of the elements Cu, Pt, Ir, Zn, Au, and Ag. The subscripts a, b, c, d, x, and y represent the atomic proportions of the respective elements in the alloy formula and have the following broad and preferred ranges in atomic percent:

| Subscript | Broad | Intermediate | Preferred | Preferred |
|---|---|---|---|---|
| a | up to 10 | up to 7 | up to 5 | up to 5 |
| b | up to 7 | 5 max. | 4 max. | 3 max. |
| c | 5-20 | 5-17 | 8-16 | 10-15 |
| d | up to 5 | 3 max. | 2 max. | 1.5 max. |
| x | 0.1-15 | 1-10 | 1-10 | 1-10 |
| y | 0.1-5 | 0.1-4 | 0.1-3 | 0.1-2 |

The balance of the alloy is iron and the inevitable impurities found in commercial grades of soft magnetic alloys and alloy powders intended for similar use or service.

In accordance with a second aspect of this invention, there is provided a powder made from the soft magnetic alloy described above, and a compacted or consolidated article made from the alloy powder. The alloy powder preferably has an amorphous structure, but may alternatively have nanocrystalline structure. In accordance with a further aspect of the invention there is provided an elongated, thin amorphous metal article such as ribbon, foil, strip, or sheet made from the alloy described above.

The foregoing tabulation is provided as a convenient summary and is not intended to restrict the lower and upper values of the ranges of the individual subscripts for use in combination with each other, or to restrict the ranges of the subscripts for use solely in combination with each other. Thus, one or more of the ranges can be used with one or more of the other ranges for the remaining subscripts. In addition, a minimum or maximum for a subscript of one alloy composition can be used with the minimum or maximum for the same subscript in another composition.

### BRIEF DESCRIPTION OF THE DRAWINGS

The nature and properties of the alloy powder according to this invention will be better understood by reference to the drawings, wherein

FIG. 1A is a photomicrograph of a batch of alloy powder according to this invention having a sieve analysis of −635 mesh (−20 μm) from Example J taken at a magnification of 400×;

FIG. 1B is a photomicrograph of batch of alloy powder according to the invention having a sieve analysis of −500+635 mesh (−25+20 μm) from Example J taken at a magnification of 400×;

FIG. 1C is a photomicrograph of a batch of alloy powder according to the invention having a sieve analysis of −450+500 mesh (−32+25 μm) from Example J taken at a magnification of 400×;

FIG. 2A is an x-ray diffraction pattern of the alloy powder shown in FIG. 1A;

FIG. 2B is an x-ray diffraction pattern of the alloy powder shown in FIG. 1B; and

FIG. 2C is an x-ray diffraction pattern of the alloy powder shown in FIG. 1C.

### DETAILED DESCRIPTION OF THE INVENTION

The alloy according to this invention is preferably embodied as an amorphous alloy powder having the general alloy formula Fe_{100 a-b-c-d-x-y} MₐM′_{b}M″_{c}M′″_{d}PₓMn_{y}. The alloy powder may also be partially nanocrystalline in form, i.e., a mixture of amorphous and nanocrystalline powder particles. Here and throughout this specification the term “amorphous powder” means an alloy powder in which the individual powder particles are fully or at least substantially all amorphous in form or structure. The term “nanocrystalline powder” means an alloy powder in which the individual powder particles are substantially nanocrystalline in structure, i.e., having a grain size less than 100 nm. The term “percent” and the symbol “%” mean atomic percent unless otherwise indicated. Furthermore, the term “about” used in connection with a value or range means the usual analytical tolerance or experimental error expected by a person skilled in the art based on known, standardized measuring techniques.

The alloy of this invention may include an element M which is selected from one or both of Ni and Co. Ni and Co contribute to the high saturation magnetization provided by a magnetic article made from the alloy powder especially when an article made from the alloy is used at a temperature above normal ambient temperature. Element M may constitute up to about 10% of the alloy composition. Better still, element M may constitute up to about 7% and preferably up to about 5% of the alloy composition. When present, the alloy contains at least about 0.2%, better yet at least about 1%, and preferably at least about 2% of element M in order to obtain the benefits attributable to those elements.

The alloy according to this invention may also include an element M′ that is selected from the group consisting of Zr, Nb, Cr, Mo, Hf, Sc, Ti, V, W, Ta, and a combination of two or more thereof. Element M′ is preferably one or more of Zr, Nb, Hf, and Ta. Element M′ may constitute up to about 7% of the alloy powder composition to benefit the glass forming capability of the material and to ensure the formation of an amorphous structure during solidification after atomization. The M′ element also restricts grain size growth during solidification which promotes formation of a nanocrystalline structure in the powder particles. Preferably element M′ constitutes not more than about 5% and better yet, not more than about 4% of the alloy powder composition. For best results the alloy contains not more than about 3% element M′. When present, the alloy contains at least about 0.05%, better yet at least about 0.1%, and preferably at least about 0.15% of elements M′ to obtain the benefits promoted by those elements.

At least about 5% of element M″ is present in the composition of the alloy to benefit the glass forming capability of the alloy and to ensure that an amorphous structure forms during solidification of the alloy. Preferably the alloy contains at least about 8% and better yet at least about 10% M″. Element M″ is selected from the group consisting of B, C, Si, Al, and a combination of two or more thereof. Preferably, M″ is one or more of B, C, and Si. Too much M″ can result in the formation of one or more undesirable phases that adversely affect the magnetic properties provided by the alloy. Therefore, the alloy powder contains not more than about 20% element M″. Preferably the alloy contains not more than about 17% and better yet not more than about 16% element M″. For best results the alloy contains not more than about 15% element M″.

The alloy according to the invention may further include up to about 5% of element M′″ which acts as a nucleation agent to promote the formation of and provide a nanocrystalline structure in the alloy. The M′″ element also helps to limit the grain size by increasing the number density of the crystalline grains that form during solidification. Preferably the crystal grain size is less than about 1 μm. M′″ is selected from the group consisting of Cu, Pt, Ir, Au, Ag, and a combination thereof. Preferably M″' is one or both of Cu and Ag. The alloy preferably does not contain more than about 3% and better yet not more than about 2% of element M′″. For best results the alloy contains not more than about 1.5% element M′″. When present, the alloy contains at least about 0.05%, better yet at least about 0.1%, and preferably at least about 0.15% of elements M′″ to obtain the benefits provided by those elements.

At least about 0.1% phosphorus and preferably at least about 1% phosphorus is present in the alloy composition to promote the formation of a glassy or amorphous structure. The alloy contains not more than 15% phosphorus and preferably not more than about 10% phosphorus to limit the formation of secondary phases that adversely affect the magnetic properties provided by the alloy.

The alloy contains at least about 0.1% manganese to benefit the ability of the alloy to form amorphous and nanocrystalline structures. It is believed that manganese also benefits the magnetic and electrical properties provided by the alloy including a low coercive force and low iron losses under high frequency operating conditions. The alloy may contain up to about 5% manganese. Too much manganese adversely affects the saturation magnetization and the Curie temperature of the alloy. Therefore, the alloy contains not more than about 4% and better yet not more than about 3% manganese. For best results the alloy contains not more than about 2% manganese.

The balance of the alloy is Fe and usual impurities. Among the impurity elements sulfur, nitrogen, argon, and oxygen are inevitably present, but in amounts that do not adversely the basic and novel properties provided by the alloy as described above. For example, the alloy powder according to the present invention may contain up to about 0.15% of the noted impurity elements without adversely affecting the basic and novel properties provided by this alloy.

The alloy powder of this invention is prepared by melting and atomizing the alloy. Preferably, the alloy is vacuum induction melted and then atomized with an inert gas, preferably argon or nitrogen. Phosphorus is preferably added to the molten alloy in the form of one or more metal phosphides such as FeP, Fe₂P, and Fe₃P. Atomization is preferably carried out in a manner that provides sufficiently rapid solidification to result in an ultrafine powder product wherein the powder particles have an amorphous structure. Alternative techniques can be used for atomizing the alloy include water atomization, centrifugal atomization, spinning water atomization, mechanical alloying, and other known techniques capable of providing ultrafine powder particles.

The alloy powder of this invention is preferably produced so that it consists essentially of particles having an amorphous structure. Preferably, the mean particle size of the amorphous powder is less than 100 μm and the powder particles have a sphericity of at least about 0.85. Sphericity is defined as the ratio of the surface area of a spherical particle to the surface area of a non-spherical particle where the volume of the spherical particle is the same as the volume of the non-spherical particle. The general formula for sphericity is defined in Wadell, H., “Volume, Shape and Roundness of Quartz Particles”, Journal of Geology, 43 (3): 250-280 (1935). The amorphous alloy powder may include a very small amount of a nanocrystalline phase. However, in order avoid an adverse effect on the magnetic properties, it is preferred that a nucleating agent (M′″) be included to promote the desired very small grain size in the nanocrystalline phase. Alternatively, or in addition, a higher cooling rate can be used during atomization to maximize to formation of the amorphous phase.

The alloy powder may be produced so that it consists essentially of nanocrystalline particles. The nanocrystalline powder is preferentially formed by including a nucleating element (M′″) as described above and by using a lower cooling rate during atomization than when atomizing the alloy to produce amorphous phase powder. The nanocrystalline powder may contain up to about 5 volume % of the amorphous phase.

The alloy may also be produced in very thin, elongated product forms such as ribbon, foil, strip, and sheet. In order to obtain an amorphous structure, a thin product form of this alloy is produced by a rapid solidification technique such as planar-flow casting or melt spinning. A thin elongated product according to the invention preferably has a thickness less than about 100 μm.

The alloy powder and the elongated thin product form of the alloy according to the invention are suitable for making magnetic cores for inductors, actuators (e.g., solenoids), transformers, choke coils, magnetic reactors. The alloy powder is particularly useful for making miniaturized forms of such magnetic devices which are used in electronic circuits and components. In this regard, a magnetic core made from the alloy powder of this invention provides a saturation magnetization (Mₛ) of at least than about 150 emu/g and a coercive force of not more than 15 Oe.

### WORKING EXAMPLES

In order to demonstrate the basic and novel properties of the alloy powder according to the invention ten (10) example heats were vacuum induction melted and then atomized to provide batches of alloy powders having the compositions shown in Table 1 below in atomic percent.

TABLE 1

| | M | M′ | | | | M″ | | | M′″ | | | |
|---|---|---|---|---|---|---|---|---|---|---|---|---|
| Example | Co | Zr | Nb | V | Ti | C | Si | B | Cu | P | Mn | Fe |
| A | | | | | | 6.1 | 1.6 | 4.3 | | 8.2 | 0.32 | 79.4 |
| B | | 0.67 | | | | 6.0 | 1.0 | 4.5 | | 8.5 | 0.31 | 79.0 |
| C | | 0.36 | 0.45 | 0.74 | 0.27 | 6.0 | 1.4 | 4.3 | | 6.9 | 0.40 | 79.0 |
| D | | 0.34 | 0.44 | 0.79 | 0.27 | 6.0 | 1.4 | 4.2 | | 6.7 | 0.41 | 79.3 |
| E | | 0.50 | 0.50 | 0.75 | | 6.1 | 1.5 | 4.3 | | 6.8 | 0.32 | 79.3 |
| F | 4.0 | | 0.15 | | | 3.8 | 7.2 | 3.9 | 0.17 | 2.4 | 0.15 | 78.1 |
| G | 4.0 | | 0.15 | | | 3.8 | 7.2 | 3.9 | 0.17 | 2.4 | 0.15 | 78.1 |
| H | 1.8 | | 1.96 | | | 0.9 | 0.04 | 5.1 | 0.79 | 7.9 | 0.85 | 80.6 |
| I | | 0.50 | | | | 5.7 | 1.1 | 4.5 | | 8.5 | 0.29 | 79.5 |
| J | | 0.50 | | | | 5.7 | 1.1 | 4.5 | | 8.5 | 0.29 | 79.5 |

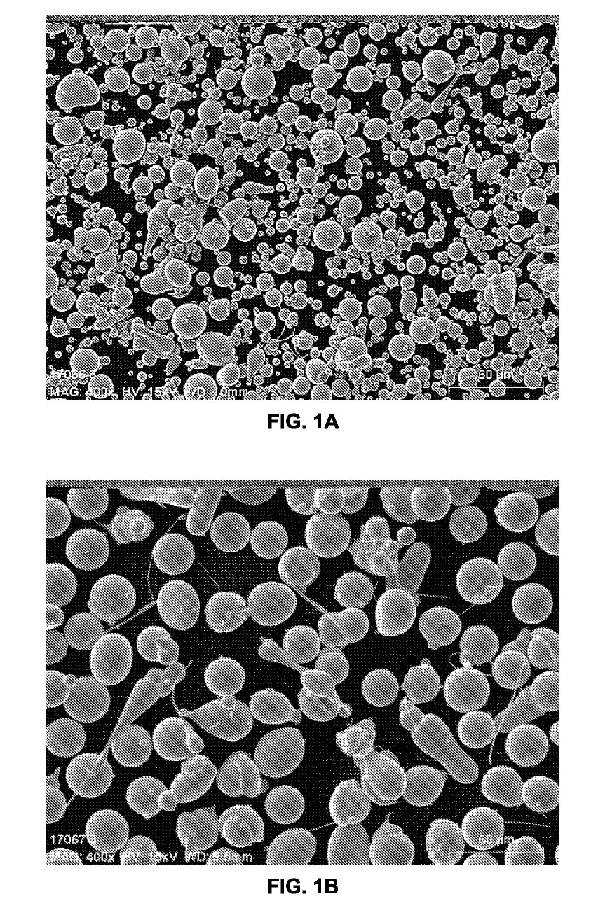

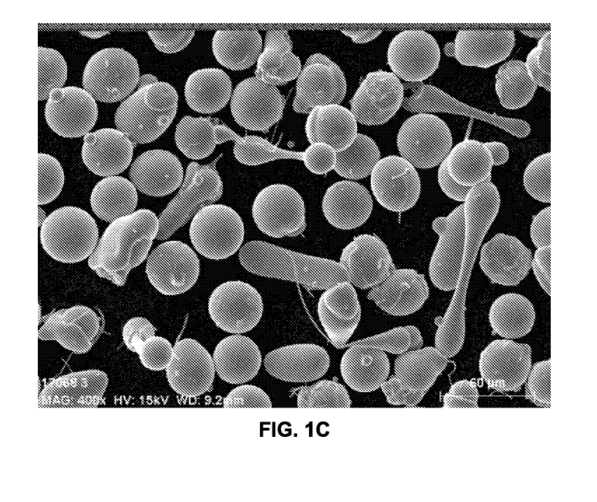

The solidified powders were sieved to determine the particle size distribution. Shown in FIGS. 1A, 1B, and 1C are photomicrographs of portions of the alloy powder particles of Example J of Table 1 that show the surface morphology of the powder particles. It can be seen from FIGS. 1A, 1B, and 1C that the powder particles are substantially all spherical in shape and range in size from about −635 mesh up to about −450 mesh.

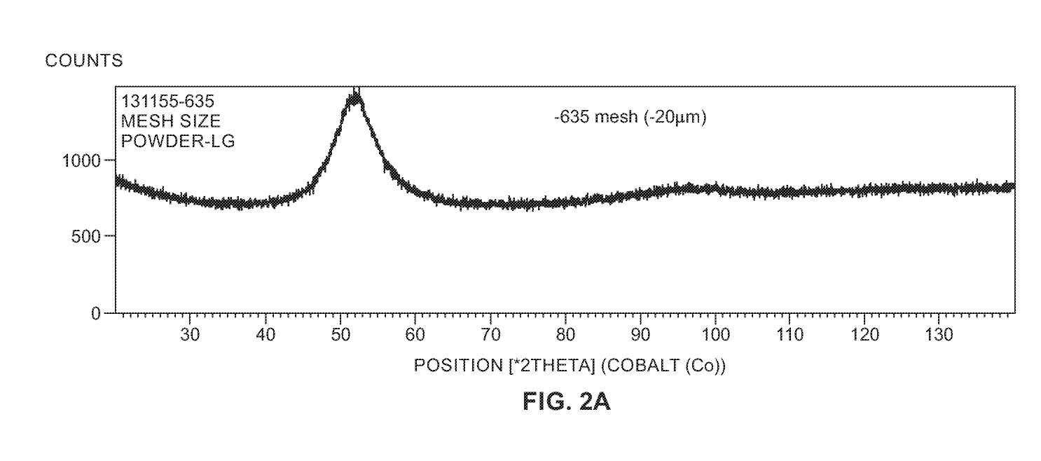

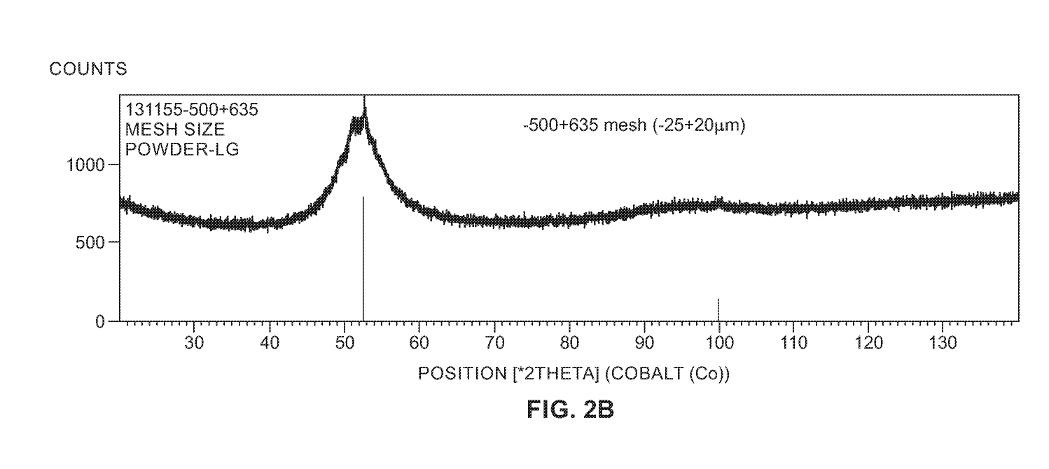

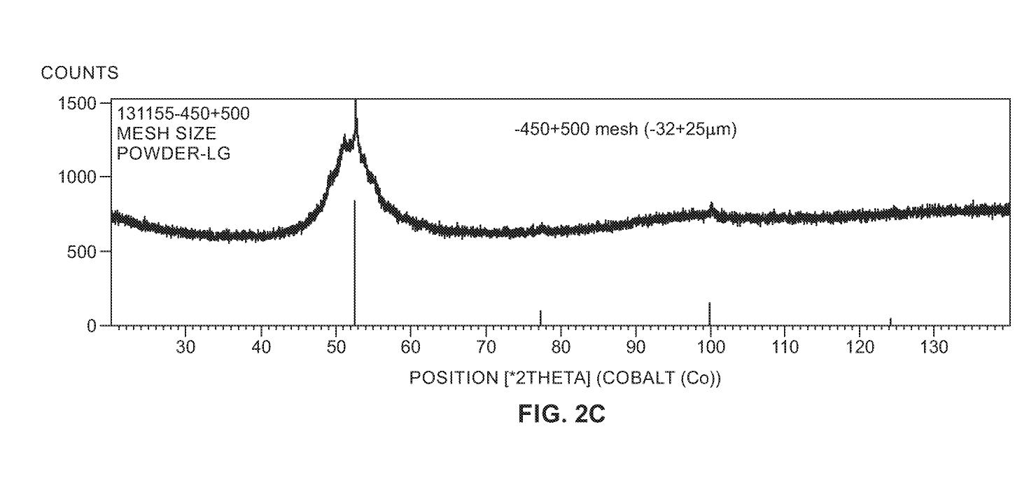

FIGS. 2A, 2B, and 2C are x-ray diffraction patterns of the alloy powder produced from the example heat. The patterns show large broad peaks for the finest powder size and some minor peaks for the larger powder sizes. These patterns are indicative of a substantially amorphous structure at all sizes with the presence of nanocrystalline grains in the larger powder sizes.

The batches of powder formed from Examples A-J were analyzed to determine their microstructures. The results of the analyses are shown in Table 2 below.

TABLE 2

| | | Ms |
|---|---|---|
| Example | Structure | (emu/g) |
| A | Amorphous with limited nanocrystallinity | 170 |
| B | Amorphous | 157 |
| C | Amorphous with limited nanocrystallinity | 147 |
| D | Amorphous | 155 |
| E | Amorphous | 155 |
| F | Mostly nanocrystalline with some amorphous phase | 177 |
| G | Mostly nanocrystalline with some amorphous phase | 179 |
| H | Mostly nanocrystalline with some amorphous phase | 165 |
| I | Amorphous | 155 |
| J | Amorphous | 160 |

The saturation magnetization property (Mₛ) for each batch was measured at an induction of 17,000 Oe. The results of the magnetic testing for each example is also shown in Table 2. The Ms provided by Example C is somewhat lower than expected and is believed to result from the presence of too much of an undesirable nanocrystalline phase.

The terms and expressions which are employed in this specification are used as terms of description and not of limitation. There is no intention in the use of such terms and expressions of excluding any equivalents of the features shown and described or portions thereof. It is recognized that various modifications are possible within the invention described and claimed herein.

1. An Fe-base soft magnetic alloy having the general formula Fe_{100 a-b-c-d-x-y} MₐM′_{b}M″_{c}M′″_{d}PₓMn_{y}, wherein
M is one or both of Co and Ni;
M′ is one or more elements selected from the group consisting of Zr, Nb, Cr, Mo, Hf, Sc, Ti, V, W, and Ta;
M″ is one or more elements selected from the group consisting of B, C, Si, and Al;
M′″ is selected from the group consisting of the elements Cu, Pt, Jr, Zn, Au, and Ag;
wherein a, b, c, d, x, and y represent the atomic proportions of the respective elements in said formula and have the following ranges, in atomic percent:
0≤a≤10,
0≤b≤7,
5≤c≤20,
0≤d≤5,
0.1≤x≤15, and
0.1≤y≤5.
and the balance of the alloy composition is iron and inevitable impurities.

2. The alloy claimed in claim 1 wherein 0≤a≤7.

3. The alloy claimed in claim 2 wherein 0.2≤a≤7.

4. The alloy claimed in claim 1 wherein 0≤b≤5.

5. The alloy claimed in claim 4 wherein 0.05≤b≤5.

6. The alloy claimed in claim 1 wherein 5≤c≤17.

7. The alloy claimed in claim 1 wherein 0.05≤d≤5.

8. The alloy claimed in claim 7 wherein 0.05≤d≤3.

9. The alloy claimed in claim 1 wherein 1≤x≤10.

10. The alloy claimed in claim 1 wherein 0.1≤y≤4.

11. An Fe-base soft magnetic alloy having the general formula Fe_{100 a-b-c-d-x-y} MₐM′_{b}M″_{c}M′″_{d}PₓMn_{y}, wherein
M is one or both of Co and Ni;
M′ is one or more elements selected from the group consisting of Zr, Nb, Cr, Mo, Hf, Sc, Ti, V, W, and Ta;
M″ is one or more elements selected from the group consisting of B, C, Si, and Al;
M′″ is selected from the group consisting of the elements Cu, Pt, Ir, Zn, Au, and Ag;
wherein a, b, c, d, x, and y represent the atomic proportions of the respective elements in said formula and have the following ranges, in atomic percent:
0≤a≤7,
0≤b≤5,
5≤c≤17,
0≤d≤3,
1≤x≤10, and
0.1≤y≤4.
and the balance of the alloy composition is iron and inevitable impurities.

12. The alloy claimed in claim 11 wherein 0.2≤a ≤7.

13. The alloy claimed in claim 12 wherein 0.2≤a ≤5.

14. The alloy claimed in claim 11 wherein 0.05≤b ≤5.

15. The alloy claimed in claim 14 wherein 0.05≤b ≤4.

16. The alloy claimed in claim 11 wherein 8≤c≤16.

17. The alloy claimed in claim 11 wherein 0≤d≤2.

18. The alloy claimed in claim 11 wherein 0.1≤d≤2.

19. The alloy claimed in claim 8 wherein 0.1≤y≤3.

20. An Fe-base soft magnetic alloy having the general formula Fe_{100 a-b-c-d-x-y} MₐM′_{b}M″_{c}M′″_{d}PₓMn_{y}, wherein
M is one or both of Co and Ni;
M′ is one or more elements selected from the group consisting of Zr, Nb, Cr, Mo, Hf, Sc, Ti, V, W, and Ta;
M″ is one or more elements selected from the group consisting of B, C, Si, and Al;
M″' is selected from the group consisting of the elements Cu, Pt, Ir, Zn, Au, and Ag;
wherein a, b, c, d, x, and y represent the atomic proportions of the respective elements in said formula and have the following ranges, in atomic percent:
0≤a≤5,
0≤b≤4,
5≤c≤16,
0≤d≤2,
0.1≤x≤10, and
0.1≤y≤3.
and the balance of the alloy composition is iron and inevitable impurities.

21. The alloy claimed in claim 20 wherein 1≤a≤5.

22. The alloy claimed in claim 20 wherein 1≤a≤3.

23. The alloy claimed in claim 20 wherein 0.1≤b≤4.

24. The alloy claimed in claim 23 wherein 0.1≤b≤3.

25. The alloy claimed in claim 20 wherein 10≤c≤15.

26. The alloy claimed in claim 20 wherein 0.1≤d≤2.

27. The alloy claimed in claim 20 wherein 0.1≤y≤2.
